(19) United States
(12) Patent Application Publication
(10) Pub. No.: US 2010/0132634 A1
(43) Pub. Date: Jun. 3, 2010

(54) Electronic System for an Internal Combustion Engine

(76) Inventor: Jeff Selano, Dallas, GA (US)

Correspondence Address: STEVEN L. SCHMID, 1824 HICKORY TRACE DRIVE, FLEMING ISLAND, FL, 32003, US

(21) Appl. No.: 12/540,426

(22) Filed: Aug. 13, 2009

Related U.S. Application Data
(63) Continuation-in-part of application No. 12/326,081, filed on Dec. 1, 2008.

(51) Int. Cl. F02B 43/08

(52) U.S. Cl. 123/3

(57) ABSTRACT

Disclosed is an electrolysis system for producing one or more gases for an internal combustion engine for enhancing combustion. The system uses stacked electrode plates including neutral plates for generating an oxygen and hydrogen gas mixture or Brown's gas which is the product of water electrolysis. The stacked plates are positioned between tensioned panels and separated by gaskets forming chambers there between for the generation of the gas mixture.

### RELATED APPLICATION

This application is a continuation-in-part of U.S. patent application Ser. No. 12/326,081, filed Dec. 1, 2008, the contents of which are hereby incorporated in their entirety.

### TECHNICAL FIELD

The present system relates to an electrolysis system for an internal combustion engine and in greater detail the system relates to an electrolysis system for producing one or more gases for an internal combustion engine for enhancing combustion.

### BACKGROUND

Modern gasoline and diesel engines are more efficient and less polluting than similar engines of even a few years ago. However, due to the increased total number of vehicles in use, levels of air pollution continue to rise even in light of more efficient and clean running vehicles. Therefore, there has been increasing pressure to develop vehicles which have lower emissions, and thus are less polluting than conventional automotive technology permits. This has spurred development of alternate fuel technologies such as electric cars and vans, natural gas and propane fuelled vehicles, hydrogen cell vehicles and the like.

While a number of these technologies are promising, some are still a long way from commercial implementation, and others appear to have reached the limit of present design capabilities without yielding a consumer acceptable product. Therefore, attention has refocused on conventional gas and diesel burning engines, and ways to render them more pollution free and efficient.

The addition of hydrogen and oxygen gases as fuel can increase the efficiency of an internal combustion engine and reduces pollution considerably. Both advantages appear to be the byproduct of faster flame speed that is as much as nine times that of gasoline, resulting in more complete combustion of the fuel in the combustion chamber. The amount of soot (semi-burnt hydrocarbons), nitrous oxide, carbon monoxide, and other pollutants is accordingly reduced, while output energy increases, for a greater fuel efficiency and horsepower.

One way to adopt hydrogen and oxygen as a fuel additive is to store the gases in tanks installed on a vehicle, with hoses connecting the tanks to the engine. However, tank storage of these volatile gases presents a persistent safety hazard, since there is always a risk of gas leak and explosion. It also requires regular trips to a service station for replenishment, which is inconvenient.

Further, the prevailing service station network would need to be retrofitted at great cost to supply these gases, which would also require widespread coordination of standards that could unduly delay acceptance of the technology. As a result of these problems with tank storage, various attempts have been made to develop systems in which the gases could be generated on board the vehicle itself, using well-known technologies such as electrolysis, for use by the engine as needed.

### SUMMARY

The present system is directed to an electrolysis system for producing one or more gases for an internal combustion engine for enhancing combustion. The system uses stacked electrode plates including neutral plates for generating an oxygen and hydrogen gas mixture or Brown's gas which is the product of water electrolysis. The stacked plates are positioned between tensioned panels and separated by gaskets forming chambers there between for the generation of the gas mixture.

In greater detail, the system includes an electrolysis cell generating one or more combustion enhancing gases from an electrolytic solution, the electrolysis cell includes a first and a second opposed mounting panel held in the opposed position by a fastener tensioning the opposed panels together. Between the panels are positioned at least three electrode plates. Further included are gaskets positioned between the electrode plates and the opposed panels, the gaskets defining a chamber between the surfaces of the electrode plates and panels.

Additionally, at least one opening is formed within each electrode plate whereby the chambers are fluidly connected to each other forming a cell chamber. Also, an opening is formed within at least one panel fluidly connected to the cell chamber for delivering a combustion enhancing gas and an opening is formed within at least one panel fluidly connected to the cell chamber for receiving an electrolytic solution.

A trap is included which is fluidly connected to the electrolysis cell for collecting and holding the solution. The trap further directs the one or more combustion enhancing gases to the intake of the internal combustion engine. The trap is also further fluidly connected to the electrolysis cell for delivering the solution to the cell. Additionally, a pump is fluidly connected to the system for recirculating the electrolytic solution within.

In a further embodiment, the system includes a cooling assembly fluidly connected to the trap and the cell such that the electrolytic solution is cooled before being delivered to the cell. The cooling assembly includes a radiator and a fan operatively aligned with the radiator whereby air is drawn through the radiator.

A pump may also be included for recirculating the electrolytic solution within the system. An electronic controller for controlling operation of the system may be included. The controller may control the rate of flow of the combustion enhancing gases from the cell to the engine can be increased when the engine is operating at higher speed. Further contemplated is the use of a plurality of electrolysis cells connected in series.

An additional embodiment includes a system having first and second opposed mounting panels held in position by a fastener tensioning the opposed panels wherein the panels are comprised of a substantially electrically nonconductive material. A further embodiment includes at least five electrode plates comprised of a electrically conductive material positioned between the first and the second panels, where at least three of the electrode plates are neutral, wherein the neutral electrodes are assembled side by side and having a positive electrode plate on a first side of the neutral electrode assembly and a negative electrode plate on a second side of the neutral electrode assembly.

### DRAWINGS

In the drawings:

FIG. 1 is an embodiment of the present electrolysis system including the electrolysis cell, trap, cooling assembly and pump for enhancing combustion by providing oxygen and hydrogen from electrolysis;

FIG. 2 depicts the opposed panels and the plates in between the panels separated by the gaskets and the panels held together by bolt assemblies;

FIG. 3 illustrates an embodiment of the electrodes as plates depicting both the positive and negative plates and the neutral plates; and

FIG. 4 depicts the gasket, plate and panel combination on one end of the cell and further depicts the opening for the solution introduction and the opening for the gas to escape the cell.

### DETAILED DESCRIPTION

The present system is directed to an electrolysis system for producing one or more gases for an internal combustion engine for enhancing combustion. The system uses stacked electrode plates including neutral plates for generating an oxygen and hydrogen gas mixture or Brown's gas which is the product of water electrolysis. The stacked plates are positioned between tensioned panels and separated by gaskets forming chambers there between for the generation of the gas mixture. The electrolytic solution can be further recycled and cooled.

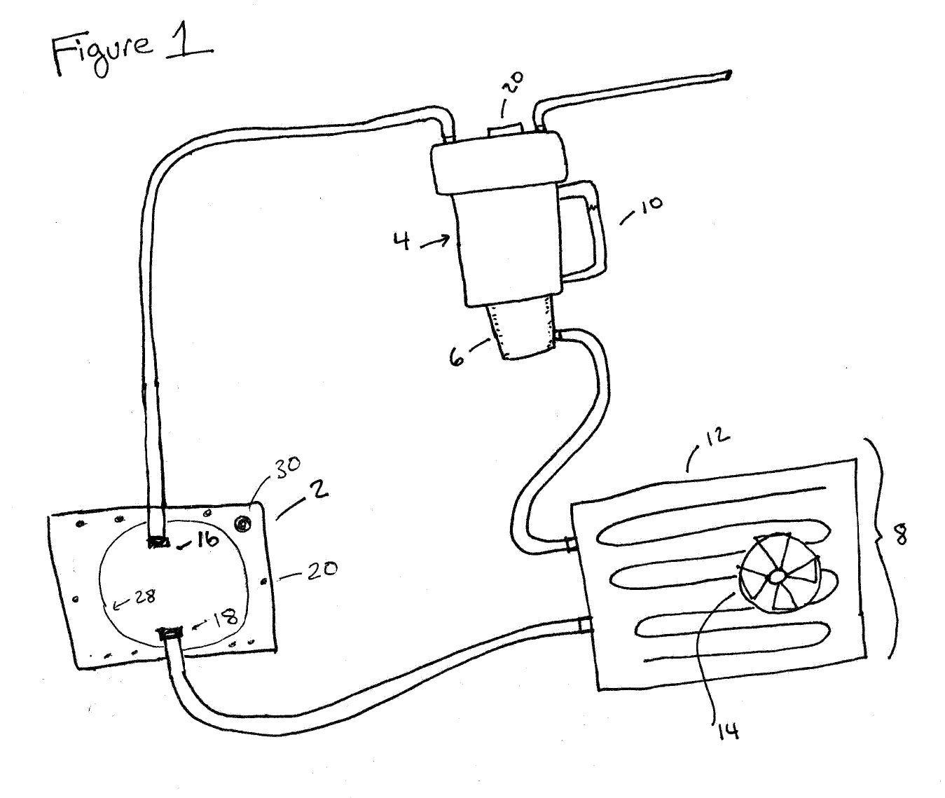

Turning now to the attached drawings, wherein like reference numerals will refer to like elements throughout, FIGS. 1-4 illustrate the various embodiments of the present system.

FIG. 1 illustrates an embodiment of the present electrolysis system including the electrolysis cell 2, trap 4, cooling assembly 8 and pump 6 for enhancing combustion by providing oxygen and hydrogen from electrolysis. The electrolysis cell 2 may one or more exit ports 16 or openings for delivering gasses to the trap 4 and then to combustion engine (not shown). Typically, the more exit ports 16 the greater the amount gas flow from the electrolysis cell 2. The electrolysis cell 2 includes a further port or opening 18 to aid in cleaning out the electrolysis cell 2.

The trap 4 is fluidly connected to the electrolysis cell 2 typically via flexible tubing capable of conveying a fluid including gas and liquid. The trap 4 can separate the liquid and gas generated from the electrolysis cell 2. The trap 4 allows gas to flow on to the engine while retaining and then recycling the liquid back to the electrolysis cell 2. Additionally, the trap 4 may act as a reservoir for the electrolytic solution so that the system can be filled via the trap 4. The trap 4 includes a fill plug 20 for filling the trap 4. A level indicator 10 may be added to the trap 4 to determine if the system needs additional electrolytic solution. The electrolytic solution can be most any solution for example but not limited to vinegar, soda and distilled water, or sodium and water.

A pump 6 may be attached to the trap 4 in the embodiment shown. However, the pump 6 for circulating the electrolytic solution in the system may be located at any position within the system to circulate the electrolytic solution. Circulating the solution aids in cooling the solution and the electrolysis cell 2. The pump 6 may be fluidly connected to the cooling assembly 8. Fluid connection may be the same in all the system, but such is not required so long as fluid may be moved as in a conduit.

The cooling assembly 8 may be comprised of a radiator 12 of most any size. Typically, the radiator is sized to fit easily within most automobiles. Optionally, a fan 14 may be added to the radiator 12 to aid in cooling.

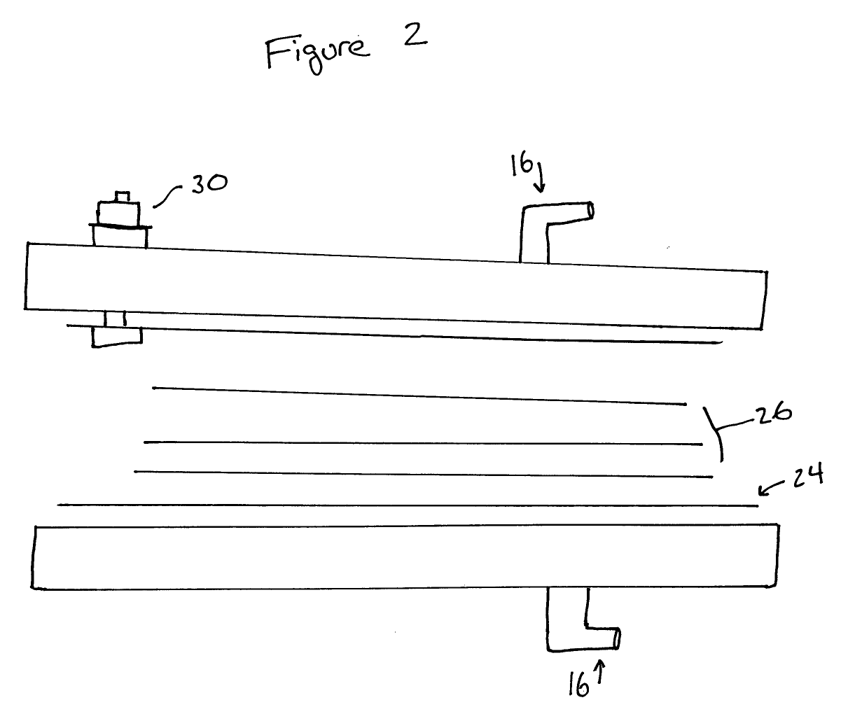

FIG. 2 the electrolysis cell 2 for generating one or more combustion enhancing gases from an electrolytic solution. The electrolysis cell 2 includes a first and a second opposed mounting panels 22 held in the opposed position by a fastener 20 tensioning the opposed panels 22 together. Between the panels 22 are positioned at least three electrode plates 24, 26. Further included are gaskets 28 positioned between the electrode plates 24, 26 and the opposed panels 22, the gaskets 28 defining a chamber 32 between the surfaces of the electrode plates 24, 26 and panels 22.

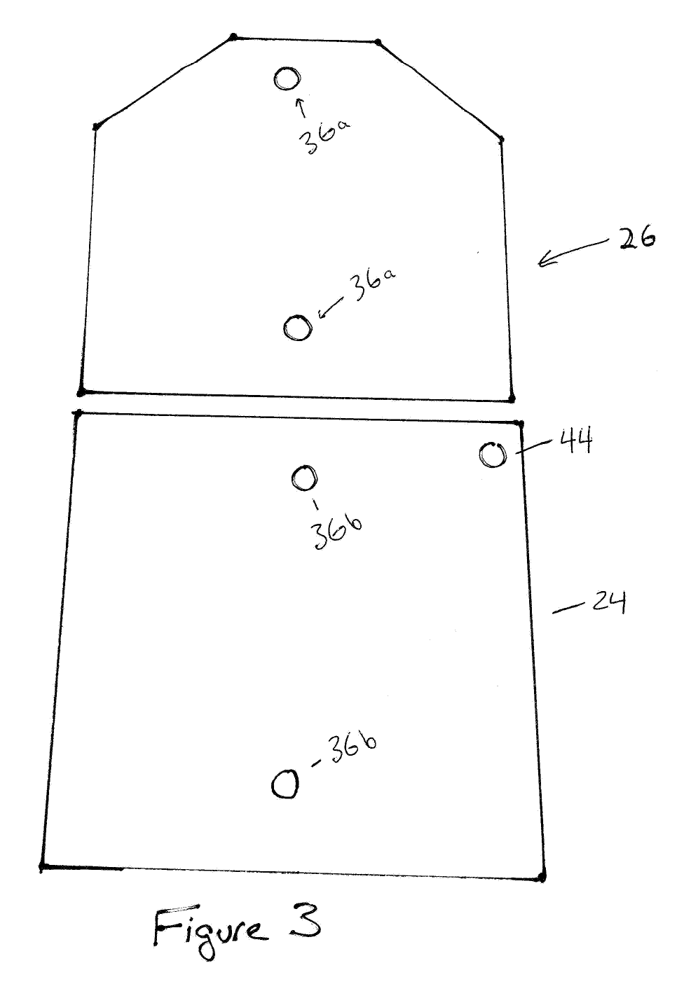

Additionally as shown in FIG. 3, at least one opening 36a-b is formed within each electrode plate 24, 26 whereby the chambers 32 are fluidly connected to each other forming a cell chamber, the combination of all the chambers 32 fluidly connected. Also, an opening 16 is formed within at least one panel 22 fluidly connected to the cell chamber for delivering a combustion enhancing gas and an opening 18 is formed within at least one panel 22 fluidly connected to the cell chamber for receiving an electrolytic solution.

Furthermore, the electrolysis cell 2 may be stacked and added in a series to produce more gas without creating a large footprint within the vehicle. Furthermore, having the trap 4 as a reservoir reduces the needed size of the electrolysis cell 2 and the volume of solution needed.

FIG. 3, depicts the electrodes plates 24, 26. Typically, the electrodes are formed from sheet metal and are flat for stacking within the electrolysis cell 2. The electrode plates 24, 26 may be formed from stainless steel. The electrode plate 24 includes openings 36b for the passage of solution and gas for form the cell chamber and functions 24 as the electrode plate 24 for the positive and negative electrode. The hole 44 connects the electrode 24 to positive and negative terminals 30 which connect respectively to positive and negative leads running from an electrical source such as a battery. The electrode plate 26 shown is one embodiment of the neutral plate 26 having openings 36a which solution and gas may flow.

The plates 24, 26 assemblies may have various configurations, but of course positive and negative electrode plates 24 are needed. In one embodiment, there is at least five electrode plates 24, 26 comprised of a electrically conductive material positioned between the first and the second panels 24, wherein at least three of the electrode plates are neutral 26, wherein the neutral electrodes 26 are assembled side by side and having a positive electrode 24 on a first side of the neutral electrode assembly and a negative electrode 24 on a second side of the neutral electrode assembly

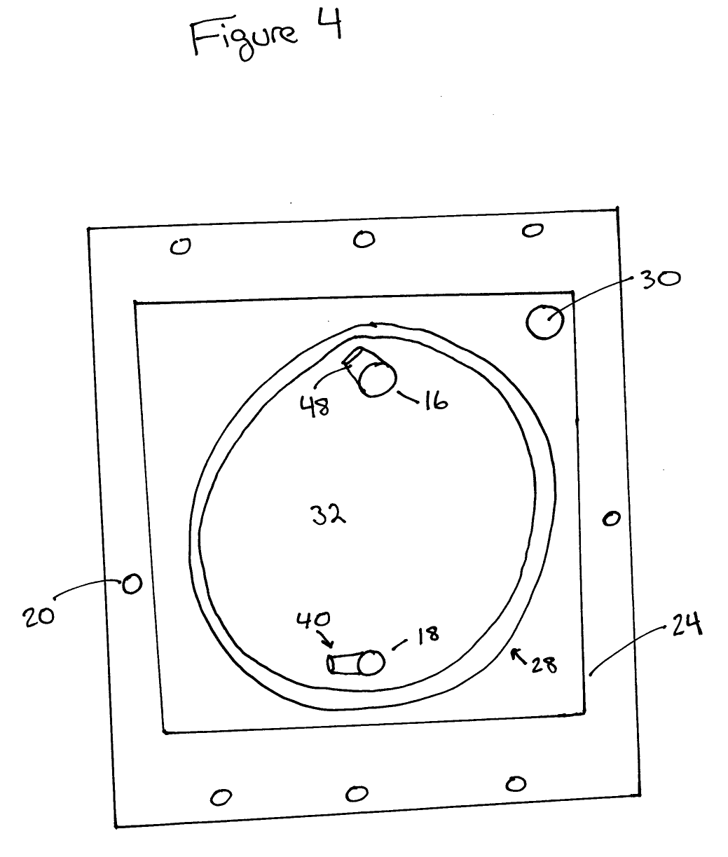

FIG. 4 depicts the gasket 28, plate 24, 26 and panel 22 combination on one end of the cell and further depicts the opening 18 for the solution introduction and the opening for the gas to escape the cell 16. The gasket 28 forms the chamber 32 in combination with the facing surfaces of either the two opposed plates 24, 26 or facing surfaces opposed panels 22 and plates 24, 26. Additionally illustrated are the intake lines 40 for the electrolytic solution provided to the cell 2 and the lines 48 taking the gas from the cell 2.

The system may further comprise an electronic controller (not shown) for controlling operation of the system and wherein the rate of flow of the combustion enhancing gases from the cell 2 to the engine can be increased when the engine is operating at higher speed.

While applicants have set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. A system for producing one or more gases for an internal combustion engine for enhancing combustion comprising:
an electrolysis cell generating one or more combustion enhancing gases from an electrolytic solution, the electrolysis cell including,
a first and a second opposed mounting panels, the panels held in the opposed position by a fastener tensioning the opposed panels,
at least three electrode plates positioned between the first and the second panels,
a plurality gaskets positioned between the electrode plates and the opposed panels, the gaskets defining a chamber between the surfaces of the electrode plates and panels and the space enclosed by the gasket;
at least one opening formed within each electrode plate whereby the chambers are fluidly connected to each other forming a cell chamber,
an opening formed within at least one panel fluidly connected to the cell chamber for delivering a combustion enhancing gas and an opening formed within at least one panel fluidly connected to the cell chamber for receiving a electrolytic solution; and
a trap fluidly connected to the electrolysis cell for collecting and holding the solution and the trap emitting one or more combustion enhancing gases whereby the trap can be fluidly connected to the intake of the internal combustion engine and the trap further fluidly connected to the electrolysis cell for delivering the solution to the cell.

2. The system of claim 1, wherein the gasket is an o-ring.

3. The system of claim 1, wherein the fastener is a bolt assembly urging and tensioning the panels and plates together separated by the gaskets forming the chambers there between.

4. The system of claim 1, further including a cooling assembly fluidly connected to the trap and the cell whereby the electrolytic solution is cooled before being delivered to the cell.

5. The system of claim 1, wherein at least five electrodes plates positioned between the panels wherein at least three of the electrodes are neutral.

6. The system of claim 5, wherein the neutral electrodes are assembled side by side and having a positive electrode on a first side of the neutral electrode assembly and a negative electrode on a second side of the neutral electrode assembly.

7. The system of claim 1, further including a pump for recirculating the electrolytic solution within the system.

8. The system of claim 1 further including an electronic controller for controlling operation of the system.

9. The system of claim 1, wherein the rate of flow of the combustion enhancing gases from the cell to the engine is increased when the engine is operating at higher speed.

10. The system of claim 1, further including a plurality of electrolysis cells.

11. A system for producing one or more gases for an internal combustion engine for enhancing combustion comprising:
an electrolysis cell generating one or more combustion enhancing gases from an electrolytic solution, the electrolysis cell including,
a first and a second opposed mounting panels, the panels held in the opposed position by a fastener tensioning the opposed panels, the opposed panels comprised of a substantially electrically nonconductive material,
at least five electrode plates comprised of a electrically conductive material positioned between the first and the second panels, wherein at least three of the electrode plates are neutral, wherein the neutral electrodes are assembled side by side and having a positive electrode on a first side of the neutral electrode assembly and a negative electrode on a second side of the neutral electrode assembly,
a plurality gaskets positioned between the electrode plates and the opposed panels, the gaskets defining a chamber between the surfaces of the electrode plates and panels and the space enclosed by the gasket,
at least one opening formed within each electrode plate whereby the chambers are fluidly connected to each other forming a cell chamber,
an opening formed within at least one panel fluidly connected to the cell chamber for delivering a combustion enhancing gas and an opening formed within at least one panel fluidly connected to the cell chamber for receiving a electrolytic solution; and
a trap fluidly connected to the electrolysis cell for collecting and holding the solution and the trap emitting one or more combustion enhancing gases whereby the trap can be fluidly connected to the intake of the internal combustion engine and the trap further fluidly connected to the electrolysis cell for delivering the solution to the cell.

12. The system of claim 11, wherein the gasket is an o-ring.

13. The system of claim 11, wherein the fastener is a bolt assembly urging and tensioning the panels and plates together separated by the gaskets forming the chambers there between.

14. The system of claim 11, further including a cooling assembly fluidly connected to the trap and the cell whereby the electrolytic solution is cooled before being delivered to the cell.

15. The system of claim 11, further including a pump for recirculating the electrolytic solution within the system.

16. The system of claim 1 further including an electronic controller for controlling operation of the system.

17. The system of claim 11, wherein a plurality of cells are connected in series.

18. The system of claim 11, wherein the cell draws less than 10 amps.

19. A system for producing one or more gases for an internal combustion engine for enhancing combustion comprising:
an electrolysis cell generating one or more combustion enhancing gases from an electrolytic solution, the electrolysis cell including,
a first and a second opposed mounting panels, the panels held in the opposed position by a fastener tensioning the opposed panels, the opposed panels comprised of a substantially electrically nonconductive material,
at least five electrode plates comprised of a electrically conductive material positioned between the first and the second panels, wherein at least three of the electrode plates are neutral, wherein the neutral electrodes are assembled side by side and having a positive electrode on a first side of the neutral electrode assembly and a negative electrode on a second side of the neutral electrode assembly.
a plurality gaskets positioned between the electrode plates and the opposed panels, the gaskets defining a chamber between the surfaces of the electrode plates and panels and the space enclosed by the gasket,
at least one opening formed within each electrode plate whereby the chambers are fluidly connected to each other forming a cell chamber,
an opening formed within at least one panel fluidly connected to the cell chamber for delivering a combustion enhancing gas and an opening formed within at least one panel fluidly connected to the cell chamber for receiving a electrolytic solution;
a trap fluidly connected to the electrolysis cell for collecting and holding the solution and the trap emitting one or more combustion enhancing gases whereby the trap can be fluidly connected to the intake of the internal combustion engine and the trap further fluidly connected to the electrolysis cell for delivering the solution to the cell; and
a pump for recirculating the electrolytic solution within the system.

20. The system of claim 19, wherein the fastener is a bolt assembly urging and tensioning the panels and plates together separated by the gaskets forming the chambers there between.
